(19) United States
(12) Patent Application Publication
(10) Pub. No.: US 2006/0056350 A1
(43) Pub. Date: Mar. 16, 2006

(54) Method and apparatus for uplink communication in a cellular communication system

(76) Inventors: Robert T. Love, Barrington, IL (US); Amitava Ghosh, Buffalo Grove, IL (US); Rapeepat Ratasuk, Hoffman Estates, IL (US); Nicholas William Whinnett, Marlborough (GB)

Correspondence Address: MOTOROLA INC, 600 NORTH US HIGHWAY 45, ROOM AS437, LIBERTYVILLE, IL, 60048-5343, US

(21) Appl. No.: 11/193,163

(22) Filed: Jul. 29, 2005

Related U.S. Application Data
(60) Provisional application No. 60/610,284, filed on Sep. 16, 2004.

(51) Int. Cl. H04Q 7/00

(52) U.S. Cl. 370/331; 455/442

(57) ABSTRACT

A cellular communication system (100) comprises a first base station (103) which schedules resource for a user equipment (101). When receiving a resource allocation message, the user equipment (101) transmits a first message comprising a transmit indication to a plurality of base stations (103-109) wherein the transmit indication is indicative of a subsequent transmission of a second message. The user equipment (101) then proceeds to determine a transmit format for the second message; and to transmit the second message to the plurality of base stations (103-109) using the transmit format. When receiving the transmit indication, the plurality of base stations (103-109) proceed to configure their receivers to receive the second message. The first message may be transmitted in a control channel and the second message may be transmitted in a user data channel. The invention is particularly applicable to a High Speed Uplink Packet Access HSUPA service in a UMTS cellular communication system and may facilitate soft handover.

### FIELD OF THE INVENTION

The invention relates to a communication system, a base station, a user equipment and methods of uplink communication in a cellular communication system.

### BACKGROUND OF THE INVENTION

In a cellular communication system, a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2^{nd} generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. A base station may be allocated a single carrier or a multiple of carriers. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3^{rd} generation systems are being rolled out to further enhance the communication services provided to mobile users. The most widely adopted 3^{rd} generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal, and as for GSM this is used for measurements of multiple cells in order to determine a serving cell. An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

Although 3^{rd} Generation systems are being rolled out, the standardisation process has continued to develop the system to provide additional functionality and new services. For example, an efficient method of supporting downlink packet data known as the High Speed Downlink Packet Access (HSDPA) service has been defined. Currently, standardisation efforts include the definition of an High Speed Uplink Packet Access service (HSUPA) for efficiently supporting packet data communication in the uplink direction.

HSDPA and HSUPA use a number of similar techniques including incremental redundancy and adaptive transmit format adaptation. In particular, HSDPA and HSUPA provide for modulation formats and code rates to be modified in response to dynamic variations in the radio environment. Furthermore, HSDPA and HSUPA use a retransmission scheme known as Hybrid Automatic Repeat reQuest (H-ARQ). In the H-ARQ scheme incremental redundancy is provided by a use of soft combining of data from the original transmission and any retransmissions of a data packet. Thus, when a receiver receives a retransmission, it combines the received information with information from any previous transmission of the data packet. The retransmissions may comprise retransmissions of the same channel data or different channel data may be transmitted. For example, retransmissions may comprise additional redundant data of a Forward Error Correcting (FEC) scheme. The additional encoding data may be combined with encoded data of previous transmissions and a decoding operation may be applied to the combined data. Hence, the retransmission may effectively result in a lower rate (higher redundancy) encoding of the same information data.

Although HSDPA and HSUPA use many similar techniques, HSUPA provides a number of additional complications with respect to HSDPA and not all techniques used for the downlink transmissions are directly applicable to the uplink scenario. In particular, in UMTS scheduling of data for communication over the air interface is performed by the network rather than in the mobile stations. Specifically for HSDPA and HSUPA aspects of the scheduling are performed in the individual base stations serving a user in order to minimise scheduling delays. This permits the air interface communication to be adapted to the dynamic variations in the radio environment and facilitates link adaptation.

For HSDPA the data to be transmitted is available at the base station and in particular the base station includes downlink transmit data buffers. Furthermore, HSDPA provides for transmissions to be made from only one base station and does not support soft handovers where the same data is simultaneously transmitted from a plurality of base stations to the same mobile station. Accordingly, the scheduling by the base station is relatively simple as the information required is available at the base station and as the scheduling by one base station may be made independently of other base stations.

However, in HSUPA, the data to be scheduled is the data which is to be transmitted from the mobile stations. Accordingly, it is important to have an efficient signalling scheme between the mobile stations and the base stations in order to allow the base stations to schedule data from the mobile stations and for the mobile stations to operate in accordance with the scheduling.

Furthermore, HSUPA provides for the use of soft handovers wherein a transmission from a mobile station may be simultaneously received by a plurality of base stations with the received signals being combined in the network. However, as the scheduling is performed by one base station in HSUPA, other base stations do not have any information on when the mobile station may transmit. Accordingly, all base stations which may be involved in a soft handover, continuously attempt to receive data transmissions from the mobile station. This requires that the base stations continuously despread the received signals with all spreading codes of mobile stations which potentially may be active. However, as the mobile stations typically transmit only for a fraction of the time, this results in a very high resource usage and in particular results in a large part of the computational resource of the receiver being used to monitor for potential transmissions from mobile stations.

Currently, a need for providing efficient signalling which may support an uplink communication channel such as HSUPA therefore exists.

Such uplink signalling is preferably compatible with all requirements and options of HSUPA.

For example, HSUPA utilises a time frame structure wherein the communication channel is divided into consecutive time frames known as TTIs (Transmit Time Intervals). However, in contrast to HSDPA where a fixed TTI of 2 msec is used, it is likely that HSUPA will allow a TTI duration of both 2 msec and 10 msec. Therefore, the uplink signalling is preferably compatible with different frame lengths.

Hence, an improved means of communication in a cellular communication system would be advantageous and in particular a system allowing for increased flexibility, reduced resource usage, reduced computational load; compatibility with HSUPA and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention, there is provided a cellular communication system comprising: a first base station for transmitting a resource allocation message for an uplink communication channel; a user equipment comprising: a first receiver for receiving the resource allocation message; a first transmitter transmitting a first message comprising a transmit indication to a plurality of base stations; the transmit indication being indicative of a subsequent transmission of a second message; a first controller determining a transmit format for the second message; and wherein the first transmitter is further operable to transmit the second message to the plurality of base stations using the transmit format; and a plurality of base stations comprising: a second receiver for receiving the first message; a configuration controller for configuring the second receiver to receive the second message in response to receiving the transmit indication; and wherein the second receiver is further operable to receive the second message in response to the configuration.

The invention may facilitate uplink communication in a cellular communication system. For example, the invention may facilitate uplink packet data communication supporting soft handover while allowing a single base station to schedule data independently of other base stations. The resource requirements associated with receiving the second message at the plurality of base stations are reduced as the base stations need only configure receive resources in response to receiving the first message. The first message may be communicated on a channel which is continuously received by the plurality of base stations such as a continuous dedicated channel or a shared channel. The invention may be suitable for different frame intervals.

The first message may be transmitted as soon as the resource allocation message is received and the second message may be transmitted after a suitable delay. The delay may allow the plurality of base stations to configure the second receiver in preparation. In particular the first message may possibly be transmitted before the transmit format for the second message is determined.

According to an optional feature of the invention, the first transmitter is operable to transmit the second message to the plurality of base stations in a soft handover transmission. The invention may facilitate soft handover operation and in particular soft handover operation for packet based services. The soft handover base stations need not schedule resource or reserve receiver resource for receiving the second message until the first message has been received. Scheduling may effectively be performed by a single base station and relevant information may be communicated to soft handover base stations via the transmit indication transmitted from the user equipment.

According to an optional feature of the invention, at least one base station out of the plurality of base stations comprise a link quality processor for determining a link quality for the user equipment; and the configuration controller of the at least one base station is operable to configure the second receiver not to receive the second message in response to the link quality.

This may reduce the computational load of the at least one base station and may in particular allow computational resource to be released for other purposes in situations where the at least one base station will not significantly contribute to the successful reception of the second message. Specifically, the configuration controller may configure the second receiver not to receive the second message if the link quality is below a given threshold.

According to an optional feature of the invention, the link quality is a signal to noise indication. This provides a suitable indication of the contribution the at least one base station may make to the reception of the second message. The signal to noise indication may for example be a signal to noise estimate, a signal to interference estimate or a combined signal to noise and interference estimate.

According to an optional feature of the invention, at least one base station out of the plurality of base stations comprise a link quality processor for determining a link quality for the user equipment; and the configuration controller of the at least one base station is operable to configure the second receiver not to receive the first message in response to the link quality.

This may reduce the computational load of the at least one base station and may in particular allow computational resource to be released for other purposes in situations where the at least one base station will not significantly contribute to the successful reception of the second message. Specifically, the configuration controller may configure the second receiver not to receive the first message if the link quality is below a given threshold. The link quality may be a signal to noise indication.

According to an optional feature of the invention, the uplink communication channel is a packet data uplink communication channel. The invention may provide an improved system for supporting the packet data uplink communication channel.

According to an optional feature of the invention, the first transmitter is operable to transmit a transmit format indication to the plurality of base stations, the transmit format indication being indicative of the transmit format. This may facilitate the reception of the second message at the plurality of base stations. The transmit format indication may for example be transmitted in the first message, the second message or may be distributed between the first and the second message.

According to an optional feature of the invention, the first controller is operable transmit a first part of a transmit format indication associated with the second message in the first message and a second part of the transmit format indication associated with the second message in the second message. This may facilitate operation and/or may provide for increased flexibility. For example, the first message may comprise a first part which indicates some of the transmit format parameters whereas the second part may indicate other transmit format parameters. This may for example allow parameters which are readily determinable to be communicated in a first message which is transmitted as soon as the resource allocation message is received whereas parameters which are determined after a delay is communicated in the second message.

According to an optional feature of the invention, the transmit indication consists in a presence of the transmit format indication in the first message. This may provide an efficient communication of a transmit indication. For example, in some embodiments no dedicated field of the first message is reserved for a transmit indication whereas a field may be allocated for transmission of an indication of one or more transmit format parameters. If this field comprises a valid transmit format indication, this indication may also function as a transmit indication.

According to an optional feature of the invention, the first message comprises a field for a transmit format code word out of a set of code words and the first transmitter is operable to transmit the transmit indication by transmitting a transmit indication code word in the field. This may provide an efficient communication of a transmit indication. For example, a predefined transmit indication code word may be interpreted as a transmit indication. The transmit indication code word may in some embodiments have an associated transmit format and may thus have a double function as a transmit format indication.

According to an optional feature of the invention, the transmit indication code word is a code word of the set of code words not associated with a transmit format. This may provide a low complexity communication of a transmit indication.

According to an optional feature of the invention, the first message comprises a field for a transmit format code word out of a set of code words and the first transmitter is operable to transmit an information content indication by transmitting an information content code word in the field. The information content indication may relate to the second message. This may provide an efficient communication of information allowing the plurality of base stations to determine the information content of, for example, the second message. The information content code word may in some embodiments be a code word which is also associated with a specific transmit format. Alternatively, the information content code word may in some embodiments be a code word which is characterised by not being associated with a specific transmit format.

According to an optional feature of the invention, the information content indication is an indication of a presence of scheduling information or a presence of transmit format information. This may provide for an efficient way of multiplexing uplink scheduling information and transmit format information with low complexity and low overhead associated with the communication of which information is present.

According to an optional feature of the invention, a code word associated with a transmit format is indicative of a presence of transmit format information and a code word not associated with the transmit format is indicative of a presence of scheduling information. This provides for an efficient way of communicating suitable content information indications and may facilitate determination of the content of e.g. the second message.

According to an optional feature of the invention, the communication channel is divided into time frames, and the transmit indication is indicative of a transmission of the second message a predetermined number of time frames after a time frame in which the transmit indication is transmitted. This facilitates operation and provides suitable performance. For example, it may facilitate the determination of when the second message is transmitted and/or may ensure that a sufficient delay is present to allow the user equipment and/or the base stations to be ready for the communication of the second message.

According to an optional feature of the invention, the first transmitter is operable to transmit the first message in a control channel and the second message in a user data channel. This may be highly advantageous in many embodiments. Specifically, the invention may allow for the plurality of base stations to only monitor the control channel while ignoring the user data channel until a transmit indication is received. In many embodiments, the control channel is continuously transmitted for other reasons, such as for power control purposes, thereby resulting in the overhead in supporting the user data channel being very low.

According to an optional feature of the invention, the communication channel is a time multiplexed channel comprising the control channel time multiplexed with the user data channel. The invention may in some embodiments provide for particularly suitable communication of uplink information compatible with time multiplexed control and user data channels.

According to an optional feature of the invention, the communication channel is divided into time frames; each time frame comprising at least a first time interval allocated for the control channel and at least a second time interval allocated for the user data channel; and the first transmitter is operable to transmit the first message in a first time frame and the second message in a second time frame. The second message may for example be transmitted in the time frame following the time frame in which the first message is transmitted. This facilitates operation and provides suitable performance. For example, it may facilitate the determination of when the second message is transmitted and/or may ensure that a sufficient delay is present to allow the user equipment and/or the base stations to be ready for the communication of the second message.

According to an optional feature of the invention, the first transmitter is operable to transmit at least the second message using an incremental redundancy retransmission scheme. The incremental redundancy retransmission scheme may for example be the Hybrid-Automatic Repeat reQuest (H-ARQ) used in some 3^{rd} generation cellular communication systems.

According to an optional feature of the invention, the cellular communication system is a UMTS cellular communication system.

According to an optional feature of the invention, the communication channel is a High Speed Uplink Packet Access (HSUPA) communication channel and the first transmitter is operable to transmit the first message on an Enhanced-Dedicated Physical Control CHannel (E-DPCCH) and the second message on an Enhanced-Dedicated Physical Data CHannel (E-DPDCH).

The invention may provide efficient signalling for supporting an uplink HSUPA channel. The invention may provide signalling which is typically compatible with all requirements and options of HSUPA. The invention may in particular allow a single base station to perform uplink scheduling. More generally, out of the set of base stations that the user equipment is communicating with, the invention may allow a subset of base stations to perform uplink scheduling. Furthermore, the invention may in some embodiments facilitate soft handover operation and may in particular allow the base stations to ignore the E-DPDCH for a user equipment until a transmit indication is received on the E-DPCCH.

According to a second aspect of the invention, there is provided a user equipment comprising: a first receiver for receiving a resource allocation message allocating resource of an uplink communication channel from a first base station; a first transmitter transmitting a first message comprising a transmit indication to a plurality of base stations; the transmit indication being indicative of a subsequent transmission of a second message; a first controller for determining a transmit format for the second message; and wherein the first transmitter is further operable to transmit the second message to the plurality of base stations using the transmit format.

According to a third aspect of the invention, there is provided a base station comprising: a receiver for receiving a first message comprising a transmit indication from a user equipment; the transmit indication being indicative of a subsequent transmission of a second message on an uplink communication channel from the user equipment; a controller for configuring the receiver to receive the second message in response to receiving the transmit indication; and wherein the receiver is operable to receive the second message in response to the configuration.

According to a fourth aspect of the invention, there is provided a method of uplink communication in a cellular communication system comprising a plurality of base stations and user equipment; the method comprising the steps of: transmitting a resource allocation message for an uplink communication channel from a first base station; receiving the resource allocation message at a user equipment; the user equipment transmitting a first message comprising a transmit indication to a plurality of base stations; the transmit indication being indicative of a subsequent transmission of a second message; receiving the first message at a plurality of base stations; configuring the plurality of base stations to receive the second message in response to receiving the transmit indication; the user equipment determining a transmit format for the second message; the user equipment transmitting the second message to the plurality of base stations using the transmit format; and the plurality of base stations receiving the second message.

According to a fifth aspect of the invention, there is provided a method of transmitting an uplink communication from a user equipment; the method comprising the user equipment performing the steps of: receiving a resource allocation message allocating resource of an uplink communication channel from a first base station; transmitting a first message comprising a transmit indication to a plurality of base stations; the transmit indication being indicative of a subsequent transmission of a second message; determining a transmit format for the second message; and transmitting the second message to the plurality of base stations using the transmit format.

According to a sixth aspect of the invention, there is provided a method of receiving an uplink communication from a user equipment; the method comprising a base station performing the steps of: receiving a first message comprising a transmit indication from a user equipment; the transmit indication being indicative of a subsequent transmission of a second message on a communication channel from the user equipment; configuring the receiver to receive the second message in response to receiving the transmit indication; and wherein the receiver is operable to receive the second message in response to the configuration.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a cellular communication system in accordance with embodiments of the invention;

FIG. 2 illustrates a user equipment in accordance with embodiments of the invention; and

FIG. 3 illustrates a base station in accordance with embodiments of the invention.

### DETAILED DESCRIPTION OF EMBODIMENTS OF THE INVENTION

The following description focuses on embodiments of the invention applicable to a 3^{rd} generation cellular communication system and in particular to a UMTS cellular communication system. However, it will be appreciated that the invention is not limited to this application but may be applied to many other cellular communication systems.

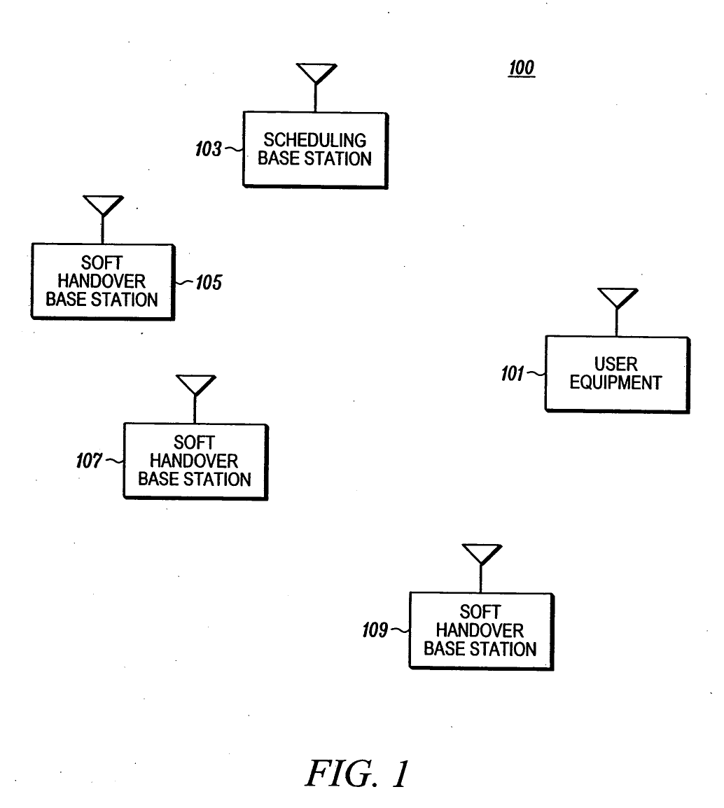

FIG. 1 illustrates a cellular communication system in accordance with embodiments of the invention.

The cellular communication system 100 comprises a large number of user equipments 101 of which (for clarity) only one is shown. An uplink packet data service from the user equipment 101 is supported by a number of base stations 103-109. In the embodiment, one base station is a scheduling base station 103 which schedules the packet data from the user equipment 101. The other base stations 105-109 do not schedule any data from the user equipment 101. However, the other base stations 105-109 are in the example soft handover base stations which are supporting a soft handover communication from the user equipment 101. Thus in the example, the uplink transmissions from the user equipment 101 are in the specific example received by four base stations 103-109. The received signals from the four base stations 103-109 are combined in order to generate the received data packets as will be well known to the skilled person.

The user equipment 101 may for example be a subscriber unit, a mobile station, a communication terminal, a personal digital assistant, a laptop computer, an embedded communication processor or any communication element communicating over the air interface.

In the embodiment of FIG. 1, the soft handover base stations 105-109 are not provided with scheduling information from the scheduling base station 103. A problem associated with this scenario is that if the soft handover base stations 105-109 do not have any information of when data transmissions may occur from the user equipment 101 they must continuously monitor the data channel on which the data packets may be sent. For a UMTS system, the user equipment 101 uses an assigned spreading code for transmitting the data packets and in order to support the soft handover, the base stations must continuously despread the signal being received using the spreading codes of all supported user equipments. This results in a high computational load for the base station.

It will be appreciated that the terms soft handover base stations 105-109 and scheduling base station 103 do not imply a difference or specific functionality of the base stations but rather is used as convenient terms referring to the specific operation of the base stations with respect to the specific uplink transmissions from the user equipment 101 in the exemplary scenario of FIG. 1.

In the embodiment of FIG. 1, the soft handover base stations 105-109 are provided with information of the scheduling for the user equipment 101 from the user equipment 101 itself. In particular, when the user equipment 101 receives a resource allocation from the scheduling base station 103 it not only proceeds to arrange for the transmission of data in the allocated resource but also transmits a transmit indication to the soft handover base stations 105-109 in order to indicate that a transmission will be made.

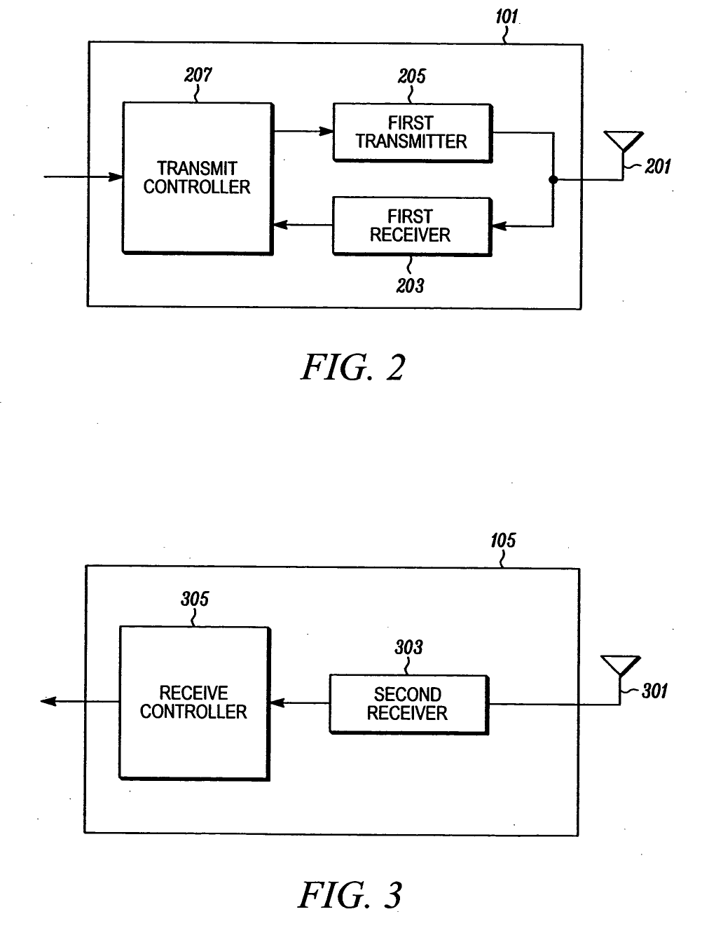

FIG. 2 illustrates the user equipment 103 of the cellular communication system 100 of FIG. 1. For clarity and brevity, FIG. 2 illustrates only functionality of the user equipment 101 required for describing the embodiment(s) to a person skilled in the art. Thus, in addition to the functional elements illustrated in FIG. 2, the user equipment 101 may typically comprise other functionality required or desired for communicating in accordance with the UMTS Technical Specifications as will be well known to the person skilled in the art.

FIG. 2 comprises an antenna 201 which is coupled to a first receiver 203 and a first transmitter 205 (for example through a duplexer (not shown)). The first receiver 203 comprises functionality for receiving signals transmitted from one or more base stations over the air interface and the first transmitter comprises functionality for transmitting signals to one or more base stations over the air interface. The first receiver 203 and the first transmitter 205 are coupled to a transmit controller 207.

In use, the scheduling base station 103 may transmit a resource allocation message to the user equipment 101. The resource allocation message is received by the first receiver 203 and is fed to the transmit controller 207. In response to receiving the resource allocation message, the transmit controller controls the first transmitter 205 to transmit a transmit indication to the base stations 103-109. The transmit indication is transmitted in a first message and is indicative of a subsequent transmission of a second message comprising the user data.

It will be appreciated that the first message and the transmit indication may be transmitted at any suitable time. Preferably, the transmit indication is transmitted immediately or soon after the resource allocation message has been received. In some embodiments, the transmit controller 207 may determine a time associated with the allocated resource and may determine a time for transmitting the first message in response to this time. For example, the transmit controller 207 may determine a time frame in which the resource is allocated and may transmit the transmit indication a fixed number of frames prior to this frame. This may allow a receiving base station to easily determine when the second message should be expected simply from the time when the transmit indication is received.

In some embodiments, the transmit indication is merely a flag that indicates that a second message will be transmitted. However, in some embodiments the transmit controller 207 may generate a transmit indication which provides an indication of when the second message is to be transmitted. In some embodiments, the first message may specifically include the information of the resource allocation message. Furthermore the transmit indication in some embodiments may be encoded with an error correcting code and protected with a checksum, and in other embodiments may be uncoded.

The transmit controller 207 furthermore proceeds to determine a transmit format for the second message. The transmit format may for example comprise a specific modulation scheme and error coding scheme. The transmit format may be selected in response to the propagation conditions and may be used to provide link adaptation. The transmit format may also be selected in response to the amount of transmission power that the user equipment has available, and/or to the amount of data that is required to be transmitted.

Following the determination of a suitable transmit format and at the time specified in the resource allocation message, the transmit controller 207 furthermore causes the first transmitter 205 to transmit the second message comprise all or part of an uplink user data packet.

FIG. 3 illustrates a soft handover base station 105 of the cellular communication system of FIG. 1. For clarity and brevity, FIG. 3 illustrates only functionality of the base station 105 required for describing the embodiment to a person skilled in the art. Thus, in addition to the functional elements illustrated in FIG. 2, the base station 105 may typically comprise other functionality required or desired for communicating in accordance with the UMTS Technical Specifications as will be well known to the person skilled in the art.

The base station 105 comprises an antenna 301 coupled to a second receiver 303 which receives signals transmitted from user equipments over the UMTS air interface. The second receiver 303 is coupled to a receive controller 305 which receives data from the second receiver 303 for outputting to the fixed network and in particular to an RNC (not shown). The receive controller 305 is further operable to control the second receiver 303 and to address other network elements in the fixed network.

In use, the second receiver 303 may receive the first message transmitted from the user equipment 101. The data of the first message may be fed to the receive controller 305 which detects the presence of the transmit indicator. Accordingly, the receive controller 305 identifies that a second message is to be transmitted from the user equipment 101 and accordingly it proceeds to configure the second receiver to receive the second message.

For example, the first message may be transmitted by the user equipment 101 on a dedicated control channel and the second receiver 303 may continuously monitor this control channel but may not monitor any user data channel of the user equipment 101. The user equipment 101 may transmit the second message on the user data channel. Accordingly, when a transmit indication is detected in a message on the control channel, the receive controller 305 proceeds to configure the second receiver 303 to receive on the appropriate user channel. Specifically, when the receive controller 305 detects the transmit indication, it may proceed to determine a time for the transmission of the second message (for example the second message may be transmitted with a predetermined delay relative to the first message) and to configure the second receiver 303 to despread and decode the received signal using the spreading code of the user data channel of the user equipment 101. The receive controller 305 may configure the second receiver 303 to soft combine the despread received signal with a previously received despread signal for the purpose of H-ARQ. Accordingly, the second receiver 303 may receive the second message and may forward this to the RNC to be combined with other signals involved in the soft handover.

Accordingly, the second receiver 303 need only monitor the control channel continuously but does not need to monitor the user data channel unless a transmit indication has been received. In many packet data services, the user equipment 101 transmit only for a relatively low fraction of the time and the approach may thus provide a significant reduction in resource use of the base stations resulting in a possible reduced cost, reduced computational load, reduced power consumption and reduced failure probability.

In some embodiments, the uplink communication channel may in particular be a High Speed Uplink Packet Access (HSUPA) communication channel.

In the example of a HSUPA, each active user equipment has an associated control channel in the form of the Enhanced-Dedicated Physical Control CHannel (E-DPCCH) channel and an associated user data channel in the form of the Enhanced-Dedicated Physical Data CHannel (E-DPDCH).

In accordance with the HSUPA specifications, the uplink traffic on the E-DPDCH is scheduled by a serving base station which in the example of FIG. 1 may be the scheduling base station 103. In order to schedule the information, the user equipment 101 must transmit scheduling information to the scheduling base station 103. For example, the user equipment 101 must communicate the amount of pending data it has for transmission. When the scheduling base station 103 has scheduled data from the user equipment 101, it transmits a resource allocation message to the user equipment 101. The resource allocation message may consist in an indication of a time interval in which the user equipment 101 may transmit and a maximum power which may be used by the user equipment 101 for the transmission.

In HSUPA, communication is performed using an incremental redundancy retransmission scheme known as H-ARQ. The H-ARQ scheme includes soft combining of original transmissions and retransmissions and provides for dynamic link adaptation. Accordingly, when the user equipment 101 receives the resource allocation message it proceeds to determine a suitable transmit format which is to be used for the transmission within the allocated time interval and maximum power threshold.

In order for the base stations to receive the transmissions, the user equipment 101 transmits transmit format information to the base stations. In response, the base stations configure their receivers to receive the transmissions using the selected transmit format. The transmit format may for example include a selection of s specific modulation scheme, error coding scheme and incremental redundancy scheme.

In HSUPA systems, the user equipment 101 accordingly transmits scheduling information and transmit format information on the E-DPCCH. Furthermore, in accordance with some embodiments of the invention, the user equipment 101 furthermore transmits a transmit indication on the E-DPCCH. The transmit indication is transmitted in advance of the user data transmission on the E-DPDCH and allows the base stations to configure themselves to receive the user data transmission on the E-DPDCH.

In HSUPA systems, any non-scheduling base stations supporting a soft handover of a user equipment do not have any information of when transmissions may be made from the user equipment. Conventionally, they must therefore continuously monitor both the E-DPCCH and the E-DPDCH for transmissions from each supported user equipment. As the E-DPCCH and the E-DPDCH are transmitted using different spreading codes, this results in a high receiver resource requirement. However, in accordance with some embodiments of the current invention, the base stations need only monitor the E-DPCCH and can ignore the E-DPDCH until a transmit indication is received on the E-DPCCH. This may provide a substantial reduction in the receiver resource usage of the base stations.

In HSUPA, communication channels are divided into time frames known as Transmission Time Intervals (TTIs). The TTIs may further be divided into slots. For HSUPA, the TTIs may have durations of either 2 msec or 10 msec and the slots have a duration of 0.67 msec. The TTIs and slots of the E-DPCCH and the E-DPDCH may be synchronised in the case that these channels are code multiplexed.

As a specific example, the information indicated in table 1 below may be transmitted by the user equipment 101 on the E-DPCCH in accordance with some embodiments of the invention.

TABLE 1

| | Information | | |
|---|---|---|---|
| Information | bits | Nslots | Field Description |
| TFRI | 10 | 3 | MCS(5) + NDI(2) + TXI(1) + |
| | | | Rsrv (2) |
| SI | 10 | 3 | PMI(5) + BOI(3) + Rsrv (2) |

In the table, the following abbreviations are used:

SI—Scheduling Information

PMI—power margin indicator, e.g. max power ratio of E-DPDCH to DPCCH

BOI—indicates queue depth and/or queue rate of fill

TFRI—Transport Format Related Information

NDI—New Data Indicator, 2 bits

MCS—Modulation Code Scheme—E-TFC indicator, 5 bits

IR version—combined with NDI (or E-TFC indicator)

TXI—Transmission Indicator

The inclusion of the Transmission Indicator TXI allows base stations to efficiently manage their resources when time and rate scheduling is employed. This is particularly important for user equipment in soft handover which are being served from different base stations (A serving cell is an active set cell that a user equipment receives scheduling signalling from. Active set handoff is used to transfer ‘serving cell’ status to a different active set cell with the assumption that there is only one serving cell per TTI for a given user equipment). It should be appreciated that instead of being within the TFRI, the TXI may be transmitted independently of either TFRI or of SI.

With the TXI, only E-DPCCH resources need to be supported for the majority of non served user equipment. Resources for E-DPDCH only need to be provided for a few users at a time that are time and rate scheduled from surrounding base stations. The TXI is sent in advance in order to give the base station time to assign the required processing resources to E-DPDCH.

In some embodiments the transmit indicator may be encoded with an error correcting code and protected with a checksum. For example, the encoding details (for example code rate) may be a function of the other information carried on E-DPCCH. For example, rate ⅓ coding may be used unless transmission indicator, TFRI and scheduling information are all transmitted in the same TTI in which case rate ½ coding may be used. The presence or absence of the SI may typically be known to the base station (based on higher layer signalling which assigns the SI reporting frequency). In this way the Node-B knows what kind of coding rate to apply (e.g. R=½ or R=⅓) to E-DPCCH.

In some embodiments, the transmit indication is an indication of the transmission of the second message on the E-DPDCH a predetermined number of time frames after the time frame in which the TXI was received (including a specified number of time slots which may be considered a fractional number of the predetermined number of time frames or a slot may be considered equivalent to a time frame).

For example, if a TXI is received during a 2 ms TTI N, this may indicate that a transmission will commence at a 2 ms TTI of N+2.

Some embodiments of the invention may thus allow an efficient uplink signaling design required to support a Hybrid ARQ protocol and base band scheduling for both 2 ms and 10 ms TTI as well as both ‘rate’ scheduling and ‘time+rate’ scheduling.

In some embodiments, base stations may further comprise a link quality processor which determines a link quality for user equipment. The link quality processor may specifically determine a signal to noise estimate (including a signal to interference estimate). The configuration controller may configure the receiver in response to the link quality and may specifically avoid configuring the receiver to receive the transmission on the E-DPCCH and/or E-DPDCH if the link quality is below a predefined threshold.

This may provide a low complexity approach to further reducing the resource requirement of the receiver. In particular, when the link quality is low, the contribution of the base station to the soft handover will be insignificant and therefore the receiver resource may be reserved for other purposes. Hence, in such embodiments receiver resources may further be reduced by allowing non-serving base stations to optionally assign these resources based on local signal quality information.

In some embodiments, the user equipment 101 is capable of transmitting a transmit format indication to the plurality of base stations where the transmit format indication is indicative of the transmit format. For a HSUPA application, the transmit format indication is transmitted in the form of the TFRI being transmitted on the E-DPCCH.

In some embodiments, the transmit format indication may be distributed over more than one message. For example, some transmit format information may be transmitted in the first message together with a transmit indication. Specifically, the transmit indication may be provided by the transmit format indication itself. For example, if a first message is received which does not comprise any transmit format information this may be considered to be an indication that no user data messages are to be transmitted whereas if a first message is received which comprises a transmit format indication this may be considered to be an indication that a further transmission of user data will follow using the transmit format indicated by the transmit format indication.

Thus, in some embodiments the transmit indication may consist in a presence of a transmit format indication in the first message.

In some embodiments, (especially for longer TTI, e.g. 10 ms), the communication channel is a time multiplexed channel wherein the control channel is time multiplexed with the user data channel. For example, the communication channel may be divided into time frames where each time frame comprises at least a first time interval allocated for the control channel and at least a second time interval allocated for the user data channel. The user equipment may then transmit the first message in a first time frame and the second message in a second time frame, such as for example the next time frame.

For example, for a HSUPA application, the E-DPCCH may be allocated to the initial 2 msecs (corresponding to three slots) of a time frame and the E-DPDCH may be allocated to the following 8 msecs (corresponding to 12 slots) of the time frame. Thus, the E-DPCCH and the E-DPDCH may be time multiplexed onto the same or different spreading codes but with only one spreading code active at a time. This may reduce the peak to average transmit power ratio thereby facilitating the design of the transmit power amplifiers of the user equipments. Also, it may be noted that with the time-multiplexing structure different channel gains are applied to E-DPCCH and E-DPDCH so that the power on E-DPCCH and E-DPDCH are controlled independently.

In this case, if the first 2 msec period comprises a transmission of transmit format indication in the form of TFRI information, this may be considered to be an indication of a subsequent transmission of the second message and the base stations may configure their receivers to receive the E-DPDCH.

In this scenario, the TFRI (or a separate transmit indication) may be transmitted during the first slot of the 2 msec period of the E-DPCCH and the following two slots of the E-DPCCH, which may be encoded separately, may comprise other information such as scheduling information and checksum data. This will provide two slots (equivalent to 1.33 msec) for the base station to configure its receiver to receive the E-DPDCH in the following 8 msec time interval. Thus the first message and the second message may be transmitted in the same time frame.

Hence in some such embodiments, a separate TXI is not required. Rather, the E-DPCCH may be divided into a part 1 and part 2. Part 1 may occupy one slot and carry TFRI. Part 2 may comprise scheduling information and checksum data (calculated over both parts 1 and 2). This structure provides time for the base station to assign resources for processing of E-DPDCH in advance. This is particularly important in soft handover for efficiently handling user equipments that are not being scheduled by the base station (i.e. a non-serving base station), so that processing resources are not required for E-DPDCH for all user equipments all the time.

In some embodiments, the first message may have a predetermined field for communicating a transmit format indication. A number of code words (such as particular binary values) may be defined to correspond to specific transmit formats. In some such embodiments, the transmit indication may be transmitted by transmission of a predefined code word in the transmit format field. In some embodiments, the predefined code word may also be associated with a specific transmit format.

However, in other embodiments, the transmit indication may be associated with a code word which is not a valid transmit format indication. Thus, when receiving the first message, the base station may extract the data of the transmit format field and may compare this to predetermined values. If the received code word is a predefined transmit indication code word, the base station proceeds to configure the receiver to receive the second message.

This may provide for a very efficient communication of the transmit indication and may in particular obviate the need for a dedicated field for the transmit indication. For example, in embodiments where 14 possible transmit formats may be used, a field of four bits will typically be reserved in uplink control messages. In this case, one of the unused bit combinations may be used for a transmit indication.

In some embodiments, a similar principle may be used to provide an indication of the type of information which is transmitted. Hence, the first message may comprise a field for a transmit format code word and the user equipment may transmit an information content indication by transmitting an information content code word in this field.

For example, the user equipment may transmit an indication of whether another field or slot comprises scheduling information or transmit format information.

In a specific example for a HSUPA application, either transmit format or scheduling information may be sent using the E-DPCCH. In the example, a first field is reserved for transmit format (TFRI) information whereas a second field may be used either for scheduling information or transmit format information. In the example, the unused or unassigned transmit format values of the first field are used to indicate whether the E-DPCCH contains TFRI or scheduling information in the second field. Specifically, if the first field contains a valid transmit format code word, this is considered to be an indication that the second field also contains transmit format information. However, if the first field contains an invalid, unused or unassigned transmit format code word, this is considered to be an indication that the second field contains scheduling information. Alternatively, if an unused TFRI code word is transmitted, this may be an indication that there is no data transmission during the TTI that the TFRI would normally correspond to.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second”, etc. do not preclude a plurality.

1. A cellular communication system comprising:
a first base station for transmitting a resource allocation message for an uplink communication channel;
a user equipment comprising:
a first receiver for receiving the resource allocation message;
a first transmitter transmitting a first message comprising a transmit indication to a plurality of base stations; the transmit indication being indicative of a subsequent transmission of a second message; and
a first controller determining a transmit format for the second message,
wherein the first transmitter is further operable to transmit the second message to the plurality of base stations using the transmit format; and
a plurality of base stations comprising:
a second receiver for receiving the first message; and
a configuration controller for configuring the second receiver to receive the second message in response to receiving the transmit indication,
wherein the second receiver is further operable to receive the second message in response to the configuration.

2. The cellular communication system as claimed in claim 1 wherein the first transmitter is operable to transmit the second message to the plurality of base stations in a soft handover transmission.

3. The cellular communication system claimed in claim 1 wherein at least one base station out of the plurality of base stations comprise a link quality processor for determining a link quality for the user equipment; and wherein the configuration controller of the at least one base station is operable to configure the second receiver not to receive the second message in response to the link quality

4. The cellular communication claimed in claim 3 wherein the link quality is a signal to noise indication.

5. The cellular communication system claimed in claim 1 wherein at least one base station out of the plurality of base stations comprise a link quality processor for determining a link quality for the user equipment; and wherein the configuration controller of the at least one base station is operable to configure the second receiver not to receive the first message in response to the link quality

6. The cellular communication system claimed in claim 1 wherein the uplink communication channel is a packet data uplink communication channel.

7. The cellular communication system as claimed in claim 1 wherein the first transmitter is operable to transmit a transmit format indication to the plurality of base stations, the transmit format indication being indicative of the transmit format.

8. The cellular communication system claimed in claim 7 wherein the first controller is operable to transmit a first part of a transmit format indication associated with the second message in the first message and a second part of the transmit format indication associated with the second message in the second message.

9. The cellular communication system claimed in claim 7 wherein the transmit indication consists in a presence of the transmit format indication in the first message.

10. The cellular communication system claimed in claim 7 wherein the first message comprises a field for a transmit format code word out of a set of code words and the first transmitter is operable to transmit the transmit indication by transmitting a transmit indication code word in the field.

11. The cellular communication system as claimed in claim 10 wherein the transmit indication code word is a code word of the set of code words not associated with a transmit format.

12. The cellular communication system as claimed in claim 7 wherein the first message comprises a field for a transmit format code word out of a set of code words and the first transmitter is operable to transmit an information content indication by transmitting a information content code word in the field.

13. The cellular communication system claimed in claim 12 wherein the information content indication is an indication of a presence of scheduling information or a presence of transmit format information.

14. The cellular communication system claimed in claim 13 wherein a code word associated with a transmit format is indicative of a presence of transmit format information and a code word not associated with the transmit format is indicative of a presence of scheduling information

15. The cellular communication system of claim 1 wherein the communication channel is divided into time frames and the transmit indication is indicative of transmission of the second message a predetermined number of time frames after a time frame in which the transmit indication is transmitted.

16. The cellular communication system of claim 1 wherein the first transmitter is operable to transmit the first message in a control channel and the second message in a user data channel.

17. The cellular communication system of claim 16 wherein the communication channel is a time multiplexed channel comprising the control channel time multiplexed with the user data channel.

18. The cellular communication system claimed in claim 17 wherein the communication channel is divided into time frames; each time frame comprising at least a first time interval allocated for the control channel and at least a second time interval allocated for the user data channel; and the first transmitter is operable to transmit the first message in a first time frame and the second message in a second time frame.

19. The cellular communication system claimed in claim 1 wherein the first transmitter is operable to transmit at least the second message using an incremental redundancy retransmission scheme.

20. The cellular communication system claimed in claim 1 wherein the cellular communication system is a UMTS cellular communication system.

21. The cellular communication system claimed in claim 20 wherein the communication channel is a High Speed Uplink Packet Access (HSUPA) communication channel and the first transmitter is operable to transmit the first message on an Enhanced-Dedicated Physical Control CHannel (E-DPCCH) and the second message on an Enhanced-Dedicated Physical Data CHannel (E-DPDCH).

22. A user equipment comprising:
a first receiver for receiving a resource allocation message allocating resource of an uplink communication channel from a first base station;
a first transmitter transmitting a first message comprising a transmit indication to a plurality of base stations; the transmit indication being indicative of a subsequent transmission of a second message; and
a first controller for determining a transmit format for the second message,
wherein the first transmitter is further operable to transmit the second message to the plurality of base stations using the transmit format.

23. A base station comprising:
a receiver for receiving a first message comprising a transmit indication from a user equipment; the transmit indication being indicative of a subsequent transmission of a second message on an uplink communication channel from the user equipment; and
a controller for configuring the receiver to receive the second message in response to receiving the transmit indication,
wherein the receiver is operable to receive the second message in response to the configuration.

24. A method of uplink communication in a cellular communication system comprising a plurality of base stations and user equipment; the method comprising the steps of:
transmitting a resource allocation message for an uplink communication channel from a first base station;
receiving the resource allocation message at a user equipment;
transmitting, from the user equipment, a first message comprising a transmit indication to a plurality of base stations, the transmit indication being indicative of a subsequent transmission of a second message;
receiving the first message at a plurality of base stations;
configuring the plurality of base stations to receive the second message in response to receiving the transmit indication;
determining, by the user equipment, a transmit format for the second message;
transmitting, from the user equipment, the second message to the plurality of base stations using the transmit format; and
receiving the second message at the plurality of base stations.

25. A method of transmitting an uplink communication from a user equipment; the method comprising the user equipment performing the steps of:
receiving a resource allocation message allocating resource of an uplink communication channel from a first base station;
transmitting a first message comprising a transmit indication to a plurality of base stations; the transmit indication being indicative of a subsequent transmission of a second message;
determining a transmit format for the second message; and
transmitting the second message to the plurality of base stations using the transmit format.

26. A method of receiving an uplink communication from a user equipment; the method comprising a base station performing the steps of:
receiving a first message comprising a transmit indication from a user equipment; the transmit indication being indicative of a subsequent transmission of a second message on a communication channel from the user equipment; and
configuring the receiver to receive the second message in response to receiving the transmit indication, wherein the receiver is operable to receive the second message in response to the configuration.
